(19) United States
(12) Patent Application Publication
(10) Pub. No.: US 2009/0324224 A1
(43) Pub. Date: Dec. 31, 2009

(54) System, method and apparatus to suppress inter-channel nonlinearities in WDM systems with coherent detection

(76) Inventor: Chongjin Xie, Morganville, NJ (US)

Correspondence Address: Lucent Technologies, Inc.;Docket Administrator (Room 2F-192), 600 Mountain Avenue, Murray Hill, NJ, 07974-0636, US

(21) Appl. No.: 12/215,796

(22) Filed: Jun. 30, 2008

(51) Int. Cl. H04J 14/02; H04J 14/06

(52) U.S. Cl. 398/65; 398/79

(57) ABSTRACT

For optical communications, apparatus and methods are provided for performing dispersion compensation management that suppresses intra-channel nonlinearities, inter-channel cross-phase modulation (XPM) and/or nonlinear polarization scattering. In optical communication, in which wavelength division multiplexed (WDM) channels are modulated, detecting and measuring channels with coherent detection is complicated due to impairments caused by neighboring channels. Apparatus and methods are provided which reduce the effect of impairments by performing in-line Periodic Group Delay (PGD) dispersion compensation on a WDM signal so as to enable detection of individual channels without severe degradation of system performance. Preferably the PGD dispersion compensator has within a channel a chromatic dispersion substantially similar to a DCF and between channels the group delay is substantially similar.

### FIELD OF THE INVENTION

The invention relates to optical transmission systems, and, in particular, to systems, apparatuses and techniques for dispersion management in wavelength-division-multiplexed (WDM) systems.

### BACKGROUND INFORMATION

Chromatic dispersion (CD) is a deterministic distortion given by the design of the optical fiber. It leads to a frequency dependence of the optical phase and its effect on transmitted signal scales quadratically with the bandwidth consumption or equivalently the data rate. Therefore the CD tolerances are reduced to 1/16, if the data rate of a signal is increased by a factor of 4. Up to 2.5 Gb/s data rate optical data transmission is feasible without any compensation of CD even at long haul distances. At 10 Gb/s, the consideration of chromatic dispersion becomes necessary, and dispersion compensating fibers (DCF) are often used. At 40 Gb/s and beyond, even after the application of DCF the residual CD may still be too large.

Polarization-mode dispersion (PMD) is a stochastic characteristic of optical fiber due to imperfections in production and installation. Pre-1990 fibers exhibit high PMD values well above 0.1 ps/√km which are border line even for 10 Gb/s. Newer fibers have a PMD lower than 0.1 ps/√km, but other optical components in a fiber link such as reconfigurable add/drop multiplexers (ROADMs) may cause substantial PMD. If 40 Gb/s systems are to be operated over the older fiber links or new fiber links with many ROADMs, PMD may become a significant detriment. PMD can be compensated by optical elements with an inverse transmission characteristics to the fiber. However, due to the statistical nature of PMD with fast variation speeds up to the few kHz range, the realization of optical PMD compensators is challenging. With increases in channel data rate, optical signal is more and more limited by the transmission impairments in optical fiber such as CD and PMD.

Polarization-division multiplexed (PDM) quadrature phase shift keying (QPSK) with coherent detection has been proposed as one of the solutions to upgrade the existing 10-Gb/s dense wavelength-division-multiplexed (WDM) networks with 50-GHz channel spacing to 40-Gb/s or 100-Gb/s. Due to the progress in high-speed electronic digital signal processing (DSP), optical coherent detection, where the full optical field information is accessible, has the potential to increase the spectral efficiency with multi-level modulation and to compensate all linear transmission impairments such as chromatic dispersion (CD) and polarization mode dispersion (PMD) in the electrical domain via DSP.

However, inter-channel cross-phase modulation (XPM) causes impairments in coherent wavelength-division-multiplexed (WDM) systems and thus decreases the transmission distance and capacity of such a system. Cross phase modulation (XPM) is nonlinear effect in which the optical intensity of one beam influences the phase change of another. XPM is the change in the optical phase of a light beam caused by the interaction with another beam in a nonlinear medium, specifically a Kerr medium. In optical fiber communications, XPM in fibers can lead to problems with channel cross talk.

For example, PDM-QPSK with coherent detection is more susceptible to fiber nonlinearities, and especially inter-channel cross-phase modulation (XPM) in DWDM systems. Inter-channel XPM significantly reduces the performance of PDM-DQPSK signals in dense WDM system. Furthermore, the degradations caused by inter-channel XPM from neighboring 10-Gb/s on-off-keying (OOK) channels is more severe in a hybrid systems where 40-Gb/s PDM-DQPSK channels co-propagate with the 10-Gb/s channels.

Existing techniques to address XPM either use electronic digital signal processing at the receiver without inline Optical Dispersion Compensators (ODC) or use Dispersion Compensation Fiber (DCF) to compensate chromatic dispersion of transmission fiber after each span. The first technique suffers from intra-channel nonlinearities, and the second technique is impaired by inter-channel nonlinearities.

### SUMMARY OF THE INVENTION

In Coherent WDM, reduction in inter-channel cross-phase modulation (XPM) is desirable in order to reduce impairments in systems that lead to decreases in the transmission distance and capacity of the system. System, method and apparatus embodiments of the invention are provided that efficiently reduce the impact of XPM on a Coherent WDM link suffering from noise and nonlinear transmission impairments. An exemplary method of optical communication according to the invention includes the use of Periodic Group Delay (PGD) dispersion compensators to compensate chromatic dispersion in transmission fiber.

PGD dispersion compensators may be deployed for one or more spans of the optical transmission network, including embodiments that have a PDG compensator for each span. Such a technique can simultaneously suppress inter-channel XPM and intra-channel nonlinearities for multi-level phase modulated signal with coherent detection. This technique can also simultaneously suppress inter-channel nonlinearities and intra-channel nonlinearities without degrading the performance of channels in the WDM systems that use various modulation formats and detection methods. The technique can significantly increase the transmission distance of the WDM signal with multi-level modulation and coherent detection, and therefore greatly increases the fiber capacity.

An exemplary optical communication system according to the invention includes an optical transmission system for carrying a wavelength-division-multiplexed (WDM) signal having at least one modulated channel that includes in-line at least one Periodic Group Delay (PGD) chromatic dispersion compensator. A plurality of in-line PGD chromatic dispersion compensators may be provided in the transmission system including an in-line PGD chromatic dispersion compensator for a predetermined number of fiber spans less than or equal to the total number of spans in the system. The WDM signal may incorporate one or more channels that are Polarization-Division-Multiplexed (PDM), phase modulated, Quadrature Amplitude Modulated (QAM), or some combination thereof.

The optical communication system may further include a demultiplexer for separating the WDM signal into at least one individual channel and a coherent detection receiver or direct detection receiver for decoding a first individual channel. A multiplexer may also be included in the optical communication system for receiving a plurality of modulated channels and generating the WDM signal, with a phase modulated channel being provided to the multiplexer from a phase modulated transmitter.

One embodiment of a method of optical communication according to the invention involves receiving a wavelength-division-multiplexed (WDM) signal having at least one modulated channel, performing in-line chromatic dispersion compensation on the WDM signal with a Periodic Group Delay (PGD) chromatic dispersion compensator, and transmitting the WDM signal that has been compensated. The embodiment may further include generating the WDM signal and transmitting the WDM signal. Demultiplexing the WDM signal that has been compensated into a first individual channel and decoding that first individual channel may also be performed.

The Periodic Group Delay (PGD) chromatic dispersion compensator may have a chromatic dispersion within a channel substantially similar to a DCF and between channels the group delay is substantially similar in one embodiment and method may include amplifying the WDM signal after the WDM signal has been compensated. Using PGD dispersion compensators for dispersion compensation management, the inter-channel XPM penalty on channels of a WDM signal can be significantly reduced.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the present invention, and wherein:

FIG. 1 is a block diagram of an exemplary optical transmission system employing a dispersion compensation module that utilizes a Periodic Group Delay (PGD) dispersion compensator;

FIG. 2 shows the characteristics of an exemplary Periodic Group Delay (PGD) dispersion compensator for use in the exemplary system of FIG. 1;

FIG. 3 is a block diagram of an exemplary embodiment of a coherent receiver for polarization-division-multiplexed phase modulated signals; and

FIG. 4 illustrates the required OSNR at BER=10⁻³ versus launching power per channel with different dispersion maps in an exemplary WDM hybrid optical transmission system in a 40-Gb/s PDM-QPSK channel propagates together with four neighboring 10-Gb/s 50% duty cycle RZ-OOK channels.

### DETAILED DESCRIPTION

Various example embodiments will now be described more fully with reference to the accompanying figures in which like numbers refer to like elements throughout the description of the figures.

Specific structural and functional details disclosed herein are merely representative for purposes of describing example embodiments. Example embodiments may, however, be embodied in many alternate forms and should not be construed as limited to only the embodiments set forth herein.

It will be understood that, although the terms first, second, etc. may be used herein to describe various elements, these elements should not be limited by these term since such terms are only used to distinguish one element from another. For example, a first element could be termed a second element, and, similarly, a second element could be termed a first element, without departing from the scope of example embodiments.

As used herein, the term “and/or” includes any and all combinations of one or more of the associated listed items, and the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent”, etc.).

Unless otherwise defined, all terms (including technical and scientific terms) used herein have the same meaning as commonly understood by one of ordinary skill in the art to which example embodiments belongs. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

It should also be noted that in some alternative implementations, the functions/acts noted may occur out of the order noted in the figures. For example, two figures/acts shown in succession may in fact be executed substantially concurrently or may sometimes be executed in the reverse order, depending upon the functionality/acts involved.

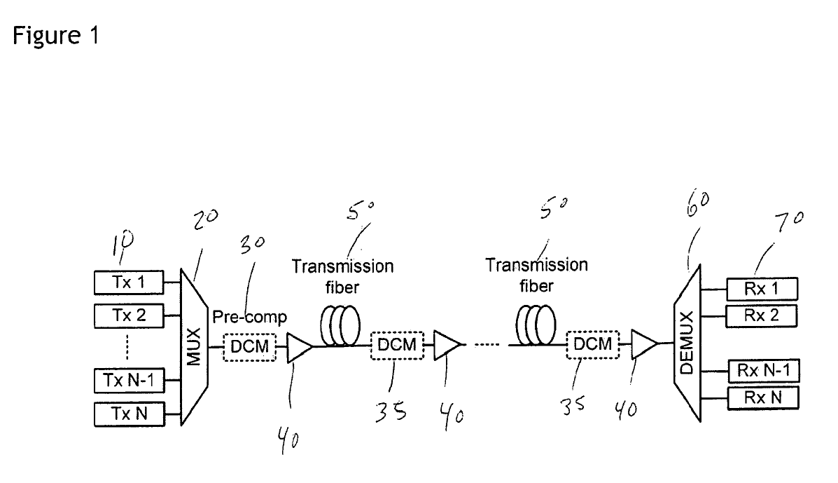

FIG. 1 is a block diagram of an exemplary optical transmission system. The exemplary optical transmission system employs a dispersion compensation module that utilizes a Periodic Group Delay (PGD) dispersion compensator. In FIG. 1, a plurality of transmitters 10 are coupled to multiplexer 20 to produce a wavelength-division-multiplexed (WDM) signal that includes at least one modulated channel. Transmitter 1 through transmitter N (10) each provide a modulated channel to multiplexer 20.

The modulated channel that is provided may be Polarization-Division-Multiplexed (PDM), phase modulated, Quadrature Amplitude Modulated (QAM), or some combination thereof. For example, the modulated channel may be a PDM-QAM channel. Further, some transmitters may generate on-off keying (OOK) channels and some transmitters may generate phase modulated channels such that the WDM channels are combinations of OOK channels and phase modulated channels. For instance, the optical communication system may be a hybrid transmission system in which 40-Gb/s PDM-QPSK signals propagate together with 10-Gb/s OOK channels. In such a hybrid transmission system, the inter-channel XPM impact on the 40-Gb/s PDM-QPSK from the 10-Gb/s OOK channels is much larger due to non-constant amplitude of OOK signals.

Pre-dispersion compensation of the WDM signal may be provided by dispersion compensation module (DCM) 30 and the pre-dispersion compensated signal then amplified by amplifier 40, which may be an Erbium doped fiber amplifier (EDFA). From the amplifier, the WDM signal is directed to the transmission fiber 50. After passing through a fiber span 50, the WDM signal is provided to an inline dispersion compensation module (DCM) 35 where periodic group delay chromatic dispersion compensation is employed to compensate the WDM signal and thereby suppress inter-channel XPM impairments.

Chromatic dispersion of an optical medium is the phenomenon that the phase velocity and group velocity of light propagating in a transparent medium depend on the optical frequency. The group delay of an optical element is defined as the derivative of the change in spectral phase with respect to the angular frequency. Group delay has the units of a time and generally in dispersive media and in the case of chromatic dispersion depends on the optical frequency.

After compensation, the compensated signal is again amplified by an amplifier 40. The amplified WDM signal is passed through a number of transmission fibers 50, a DCM modules 35 and amplifiers 40 serially in order to traverse the optical transmission system before being received at demultiplexer 60. For a coherent receiver, an optical demultiplexer is not necessary. Pre-dispersion compensation by dispersion compensation module (DCM) 30 and inline dispersion compensation modules (DCM) 35 may provide the same delay to the WDM signal or may have different characteristics. While a DCM and amplifier are illustrated for each fiber span, there need not be a one to one relation between the number of DCMs, the number of amplifiers and the number of fiber spans. In all cases thought, the optical link suffers from fiber nonlinearity, chromatic dispersion (CD) and polarization mode dispersion (PMD) and inter-channel XPM which significant degrades the performance of the WDM system.

Demultiplexer 60 separates the received WDM signal into at plurality of individual channels. Each individual channel is provided to a receiver 70 for decoding of the data information of the signal stream. Each receiver 1 through receiver N 70 may be a coherent detection receiver and/or direct detection receiver for decoding an individual channel.

For example, the system shown in FIG. 1 may have five channels with 50-GHz channel spacing in which the middle channel is the reference channel having a 42.8-Gb/s PDM-QPSK signal, and the other four surrounding channels may be 42.8-Gb/s PDM-QPSK channels or 10.7-Gb/s return-to-zero (RZ) OOK channels. The QPSK signal at each polarization can be generated with a nested Mach-Zehnder modulator with inphase and quadrature tributaries driven by a 10.7-Gb/s De Bruijn bit sequence non-return-to-zero (NRZ) signal. The polarizations of the five channels may be aligned or the polarization of the reference channel may be rotated by 45° relative to the other channels. The polarizations of five channels need not be aligned.

For dispersion management, −250 ps/nm pre-dispersion compensation can be provided and the inline dispersion compensation modules (DCMs) 35 may be set to have 30 ps/nm residual dispersion per span. The DCMs are PGD dispersion compensators. The dispersion compensation provided at each DCM need not be exactly the same; that is, various amounts of dispersion compensation may be provided at each DCM.

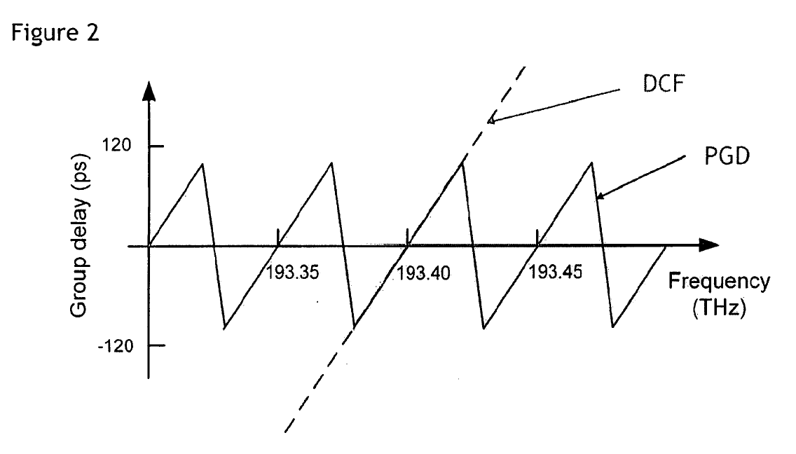

FIG. 2 shows the characteristics of an exemplary Periodic Group Delay (PGD) dispersion compensator for use in the exemplary system of FIG. 1. Within a channel, dispersion is the same as a dispersion compensation fiber (DCF). Between channels, there are no reregistering/realigning of bit patterns. Within a channel, a PGD dispersion compensator has the same dispersion characteristics as DCF, but between channels, it does not induce any walk off. The group delay response is characterized by a first period such that only one group delay peak occurs within a first channel. The features of a PGD dispersion compensator can also be implemented by using a fiber grating or a virtually imaged phased array (VIPA).

In one embodiment, each PGD chromatic dispersion compensator in a dispersion compensation module (DCM) 35 may have a chromatic dispersion of 600 ps/nm with a channel spacing of 50 GHz. The characteristic of the PGD compensator may between DCM modules. In other words, various amounts of dispersion compensation may be provided at each DCM module.

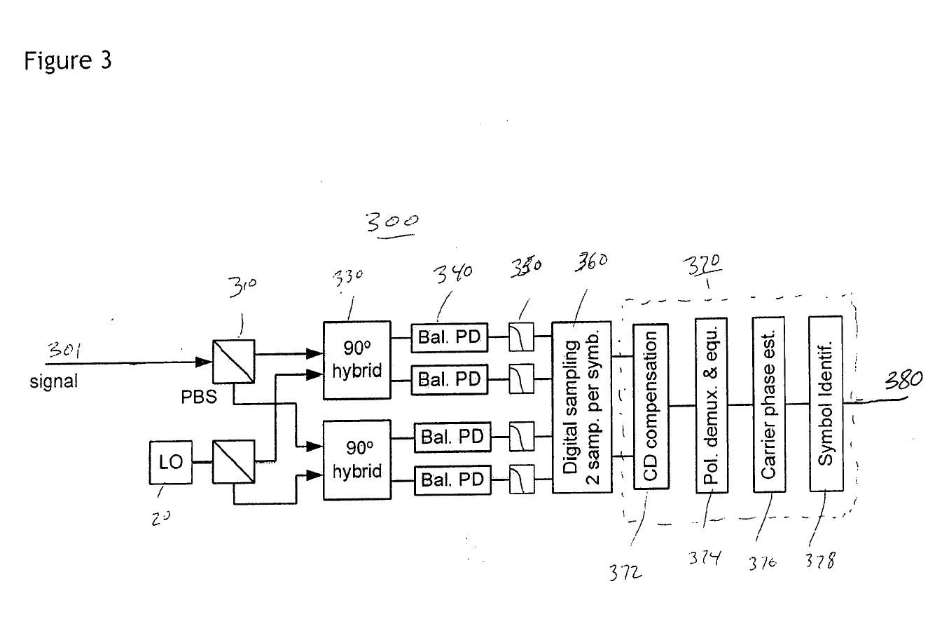

FIG. 3 is a block diagram of an exemplary embodiment of a coherent receiver for polarization-division-multiplexed phase modulated signals. WDM signal 310 propagates through the optical system (not shown) and a channel of the DWM signal is received at receiver 300 of the optical system. As a result of propagation in the transmission link, noise will be added to the WDM signal and its constituent channels. After passing through a polarization beam splitter (PBS) 310, each polarization of the demultiplexed signal is combined with a local oscillator (LO) 320 in a 90° hybrid 330. From the hybrids, the four tributaries of the signal are detected by four balanced detectors 340. The signal after each detector is first filtered by an anti-aliasing filter 350 and then sampled at a predetermined rate by digital sampling module. A digital signal processor (DSP) 370 then processes the sampled signal to determine the symbols received in the channel of the WDM signal. The DSP is includes at least four steps/modules. A CD compensation module 372 performs chromatic dispersion compensation. A polarization demultiplexing and equalizing module 374 reduces the crosstalk from the other polarization. For example, the polarization demultiplexing may utilize with FIR filters employing the Constant Modulus Algorithm (CMA). A carrier phase estimation module 376 using block Mth power scheme and a symbol identification module 378 identifies the received symbol. After symbol identification, data comprising a symbol which is part of a symbol sequence is output 380.

For example the receiver may be a 40-Gb/s PDM-QPSK coherent receiver. In such a receiver the local oscillator (LO) may have a linewidth of 2 MHz and the anti-aliasing filter may be a 2^{nd}-order Butterworth filter with 3-dB bandwidth of 6.42-GHz with the filtered signal being sampled at two samples per symbol. CD compensation may be provided with a 35-tap finite impulse response (FIR) filter and polarization demultiplexing provided with four 7-tap FIR filters employing the Constant Modulus Algorithm. The preferred block length for carrier phase estimation is 10 blocks.

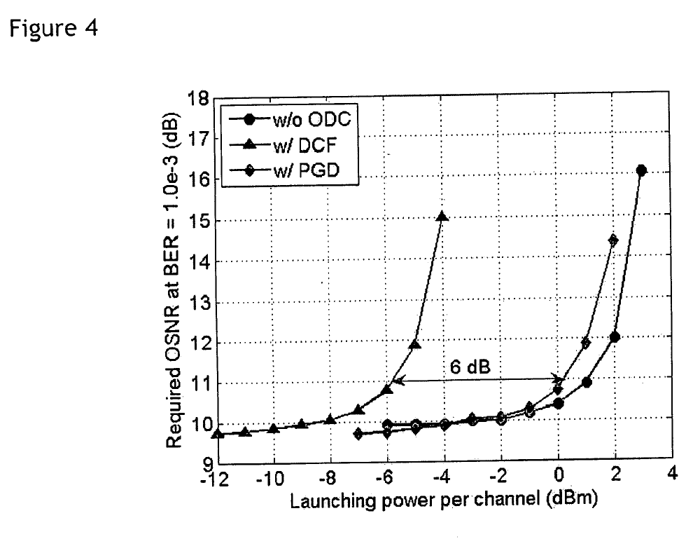

FIG. 4 details the performance of a 40-Gb/s PDM-QPSK with four neighboring 10-Gb/s 50% duty cycle RZ-OOK channels propagating together in an a WDM optical transmission system with Coherent Detection. Inter-channel XPM significantly degrades the performance of the WDM system with dispersion management using dispersion compensation fiber (DCF) due to the slow walk off between channels. Within a channel, a PGD dispersion compensator has the same dispersion characteristics as DCF, but between channels, it does not induce any walk off.

When 40-Gb/s PDM-QPSK signals propagate together with 10-Gb/s OOK channels in a hybrid transmission system, the inter-channel XPM impact on the 40-Gb/s PDM-QPSK from the 10-Gb/s OOK channels is much larger due to non-constant amplitude of OOK signals. Inter-channel XPM from the neighboring 10-Gb/s OOK channels severely degrades the performance of the 40-Gb/s PDM-QPSK signal in a system with DCF. Without inline optical dispersion compensators (ODCs), the inter-channel XPM effect from the OOK channels is much smaller due to the average effect of fast channel walk off. However, without inline ODCs, the reach of the 10-Gb/s OOK channels is severely limited. This problem can be partially solved by using dispersion management with PGD dispersion compensators. As shown in FIG. 4, by using PGD dispersion compensators, the 40-Gb/s PDM-QPSK can achieve a similar performance as that without inline ODCs, about 6-dB improvement of inter-channel nonlinearity tolerance compared with the system using DCF. The 10-Gb/s OOK channels do not have the degraded performance with PGD dispersion compensators. Inter-channel XPM from the neighboring 10-Gb/s OOK channels will cause a large spread in the signal constellation when DCF is used. In the system without inline ODCs or using PGD dispersion compensations, at the same launching power, signal constellations diagrams are clearer.

Various of the functions described above may be readily carried out by special or general purpose digital information processing devices acting under appropriate instructions embodied, e.g., in software, firmware, or hardware programming.

What is claimed is:

1. An optical communication system comprising:
an optical transmission system adapted to carry a wavelength-division-multiplexed (WDM) signal having at least one modulated channel, the optical transmission system including in-line at least one Periodic Group Delay (PGD) chromatic dispersion compensator.

2. The optical communication system of claim 1 further comprising
a demultiplexer for separating the WDM signal into at least one individual channel; and
at least one coherent detection receiver or direct detection receiver for decoding a first individual channel.

3. The optical communication system of claim 1 wherein the WDM signal includes at least one Polarization-Division-Multiplexed (PDM) modulated channel.

4. The optical communication system of claim 1 wherein the WDM signal includes at least one phase modulated channel.

5. The optical communication system of claim 1 wherein the multiplexed phase modulated signal includes at least one Quadrature Amplitude Modulated (QAM) channel.

6. The optical communication system of claim 1 further comprising:
a multiplexer for receiving a plurality of modulated channels and generating the WDM signal.

7. The optical communication system of claim 1 further comprising:
a phase modulated transmitter for providing a first phase modulated channel.

8. The optical communication system of claim 1 wherein the optical transmission system includes a plurality of in-line PGD chromatic dispersion compensators.

9. The optical communication system of claim 1 wherein the optical transmission system includes
a first plurality of spans; and
an in-line PGD chromatic dispersion compensator for each of a second plurality of the spans.

10. A method of optical communication comprising:
receiving a wavelength-division-multiplexed (WDM) signal having at least one modulated channel;
performing in-line chromatic dispersion compensation on the WDM signal with a Periodic Group Delay (PGD) chromatic dispersion compensator; and
transmitting the WDM signal that has been compensated.

11. The method of optical communication in claim 10 further comprising:
generating the WDM signal; and
transmitting the WDM signal.

12. The method of optical communication in claim 10 further comprising:
demultiplexing the WDM signal that has been compensated into at least a first individual channel; and
decoding at least the first individual channel.

13. The method of optical communication in claim 10 wherein the Periodic Group Delay (PGD) chromatic dispersion compensator has within a channel a chromatic dispersion substantially similar to a DCF and wherein between channels a group delay is substantially similar.

14. The method of optical communication in claim 10 wherein the WDM signal includes at least one Polarization-Division-Multiplexed (PDM) modulated channel.

15. The method of optical communication in claim 10 wherein the WDM signal includes at least one phase modulated channel.

16. The method of optical communication in claim 10 wherein the WDM signal includes at least one Quadrature Amplitude Modulated (QAM) channel.

17. The method of optical communication in claim 10 further comprising:
multiplexing a plurality of phase modulated channels into the WDM signal.

18. The method of optical communication in claim 10 further comprising:
amplifying the WDM signal that has been compensated.

19. The method of optical communication in claim 10 wherein the performing step occurs for each of a plurality of spans of the optical transmission system.

20. A Wavelength-Division-Multiplexed (WDM) network for optical communication, the network comprising:
a Periodic Group Delay (PGD) chromatic dispersion compensator for receiving a Wavelength-Division-Multiplexed (WDM) signal including at least one modulated channel and compensating said received multi-wavelength signal;
an amplifier for amplifying said multi-wavelength signal subject to compensation.
